(19) United States
(12) Patent Application Publication
(10) Pub. No.: US 2024/0131878 A1
(43) Pub. Date: Apr. 25, 2024

(54) SYSTEM AND METHOD FOR SETTING MULTIPLE TIRE SENSOR IDENTIFICATION CODES USING HANDHELD DEVICE

(71) Applicant: Orange Electronic Co., Ltd, TAICHUNG CITY (TW)

(72) Inventor: MING-YUNG HUANG, TAICHUNG CITY (TW)

(21) Appl. No.: 18/189,924

(22) Filed: Mar. 23, 2023

(30) Foreign Application Priority Data
Oct. 20, 2022 (TW) 111140046

(51) Int. Cl. B60C 23/04

(52) U.S. Cl. CPC B60C 23/0415; B60C 23/0442

(57) ABSTRACT

A system for setting multiple tire sensor identification codes includes a database and a handheld device. The database is for inputting and storing multiple vehicle owner information and multiple tire sensor identification codes associated with the vehicle owner information. The handheld device is for obtaining the multiple tire sensor identification codes from the database and transmitting the multiple tire sensor identification codes to multiple tire sensors so that each of the tire sensors stores one tire sensor identification code.

### RELATED APPLICATIONS

This application claims priority to Taiwan Application Serial Number 111140046, filed Oct. 21, 2022, which is herein incorporated by reference.

### BACKGROUND

### Technical Field

The present disclosure relates to a system and method for setting multiple tire sensor identification codes using a handheld device.

### Description of Related Art

In order to improve driving safety, most of the existing vehicle tires are equipped with a tire sensor (e.g., TPMS sensor) that can be used to detect tire status, such as tire pressure, temperature, etc. The existing tire pressure sensor is installed inside a tire to detect the tire pressure, and then a tire pressure signal containing an identification code of the tire pressure sensor is transmitted to a tire pressure receiver, such as electronic control unit (ECU) of car, which is the car computer. The car computer can identify different tire pressure sensors, owing to each of the tire pressure sensors has a unique identification code itself. For example, assuming that four tire pressure sensors are installed on four wheels of the car, and the identification code of each of the tire pressure sensors is 1, 2, 3, 4, respectively. When the battery power of the four tire pressure sensors is exhausted, about to run out or the tire pressure sensors are damaged, it is necessary to replace the old ones with new tire pressure sensors, and the identification code of each of the new tire pressure sensors is 5, 6, 7, 8, respectively. However, the car computer cannot identify the new tire pressure sensors with identification codes 5, 6, 7, 8, thus the car computer cannot receive the tire pressure signals. Therefore, the car computer must enter a learning mode to learn the new identification codes, so that the car computer can receive the tire pressure signal from the tire pressure sensors with identification codes 5, 6, 7, and 8, and the new tire pressure sensors will be recognized by the car computer. However, it needs certain operation processes to enter the learning mode of the car computer, and it will take a lot of time. This is due to the vehicle owner may accidentally enter the learning mode by just pressing a button, which may cause safety problems of the car, therefore the car manufacturer commonly produces complicated operation processes of entering the learning mode of the car computer, so that the vehicle cannot enter the learning mode easily. Therefore, a method which uses a setting tool and without entering the learning mode of the car computer is developed. In this method, the identification codes 1, 2, 3, 4 are inputted into the setting tool firstly, after the setting tool obtains the identification codes 1, 2, 3, 4, the identification codes 1, 2, 3, 4 are transmitted to the four new tire pressure sensors by the setting tool, and the identification codes of the four new tire pressure sensors will be replaced by 1, 2, 3, 4. And then the new tire pressure sensors will transmit the tire pressure signal to the car computer with the identification codes 1, 2, 3, 4. However, in this method, the identification codes cannot be inputted at a time into the setting tool. For example, if a tire pressure sensor of the left front wheel is damaged (e.g. run out of the electric power), the old tire pressure sensor of the left front wheel should be removed firstly, and then selecting the left front wheel on the operation interface of the setting tool, and then using the keyboard on the operation interface of the setting tool to input the identification code as 1, and then transferring the identification code 1 from the setting tool to the new tire pressure sensor, and finally installing a new tire pressure sensor in a location of the left front wheel. The above processes must be operated four times due to a car has four tires. In another method, when the old tire pressure sensor of the left front wheel still has a little electric power, the setting tool transmits a wireless low-frequency signal to the old tire pressure sensor, this is a so-called trigger action. When the old tire pressure sensor is triggered, it will transmit back tire pressure signal with identification code 1 to the setting tool; at the time, this tire pressure signal is a high-frequency RF signal, and then the setting tool transmits the identification code 1 to the new tire pressure sensor. This kind of method requires four times operations as well. The reason that using the setting tool to select the tire location is to prevent confusion. The four old tire pressure sensors are commonly removed at a time, and then the four old tire pressure sensors are used one by one to transmit the identification code to the setting tool. The purpose of selecting the tire location on the setting tool is to record that the old tire pressure sensor in which location of the tire has transmitted identification code to the setting tool. When this identification code is transmitted to the new tire pressure sensor, the user can know that on which tire location the new tire pressure sensor should be installed. There is another method that using the setting tool with a cable, one end of the cable is plugged into the setting tool, the other end of the cable is plugged into an on-board diagnostic system (OBD), and then the identification codes of the four old tire pressure sensors and the installation location of each of the tire pressure sensors on the tires can be read from the car computer to the setting tool. However, it also takes time for the user to plug one end of the cable into the setting tool and the other end of the cable into the OBD. Furthermore, this method is not available if the cable is accidentally lost. Another issue may be occurred when the data stored in the car computer is incorrect or missing.

### SUMMARY

According to one aspect of the present disclosure, a system for setting multiple tire sensor identification codes is provided. The system includes a database, and a handheld device. The database is for inputting and storing multiple vehicle owner information and multiple tire sensor identification codes associated with the vehicle owner information. The handheld device is for obtaining the multiple tire sensor identification codes from the database and transmitting the multiple tire sensor identification codes to multiple tire sensors so that each of the tire sensors stores one tire sensor identification code.

According to one aspect of the present disclosure, a system for setting a tire sensor identification code is provided. The system includes a database and a handheld device. The database is for inputting and storing a vehicle owner information and a tire sensor identification code associated with the vehicle owner information. The handheld device is for obtaining the tire sensor identification code from the database and transmitting the tire sensor identification code to a tire sensor so that the tire sensor stores the tire sensor identification code.

According to one aspect of the present disclosure, a method for setting multiple tire sensor identification codes is provided. The method includes: providing a database for inputting and storing multiple vehicle owner information and multiple tire sensor identification codes associated with the vehicle owner information; providing a handheld device for obtaining the multiple tire sensor identification codes from the database; and transmitting one of the multiple tire sensor identification codes to one tire sensor by the handheld device.

According to one aspect of the present disclosure, a handheld device is provided. The handheld device includes a network module, wherein the network module is electrically connected to a database. The network module obtains at least one tire sensor identification code from the database and transmits the at least one tire sensor identification code to at least one tire sensor so that the tire sensor stores at least one tire sensor identification code.

According to one aspect of the present disclosure, a device for setting a tire sensor identification code includes a handheld device. The handheld device includes a first circuit board, a first chip module, a network module, and output module and a power supply module. The first chip module is installed on the first circuit board, the network module, the output module and the power supply module are electrically connected to the first chip module and are controlled by the first chip module. The network module receives a network signal from a database and transmits the network signal to the first chip module, wherein the network signal comprises an identification code of an outer tire sensor or an identification code of a code-writable tire sensor. The power supply module provides electricity to the handheld device. The code-writable tire sensor includes a microprocessor module, a detection module, a transmission module, a power module and a receiver module, wherein the detection module, the transmission module, the power module and the receiver module are electrically connected to the microprocessor module. The output module of the handheld device is controlled by the first chip module to transmit the identification code to the receiver module of the code-writable tire sensor. The detection module is controlled by the microprocessor module to detect a tire pressure value. The transmission module is controlled by the microprocessor module to transmit a radio frequency (RF) signal including the tire pressure value and the identification code of the code-writable tire sensor. The microprocessor module comprises a memory unit, wherein the memory unit is a readable and writable memory unit. The receiver module is controlled by the microprocessor to receive the identification code of the outer tire sensor and store the identification code to the memory unit and the power module provides electricity to the code-writable tire sensor.

According to one aspect of the present disclosure, a method for setting a tire sensor identification code includes: obtaining an old identification code of an old tire sensor from a database by using a network signal; and inputting the old identification code to another code-writable tire sensor to form an identification code of the code-writable tire sensor.

### BRIEF DESCRIPTION OF THE DRAWINGS

The present disclosure can be more fully understood by reading the following detailed description of the embodiment, with reference made to the accompanying drawings as follows:

FIG. 1 is a diagram showing an architecture of a system for setting tire sensor identification codes;

FIG. 2 is a block diagram showing an architecture of the handheld device of FIG. 1;

FIG. 3 is a diagram showing an appearance of a physical product of the handheld device of FIG. 2;

FIG. 4 is a block diagram showing an architecture of a tire sensor;

FIG. 5 is a flow chart showing a method for setting tire sensor identification codes according to one embodiment of the present disclosure; and

FIG. 6 is a flow chart showing a method for setting tire sensor identification codes to a database according to another embodiment of the present disclosure.

### DETAILED DESCRIPTION

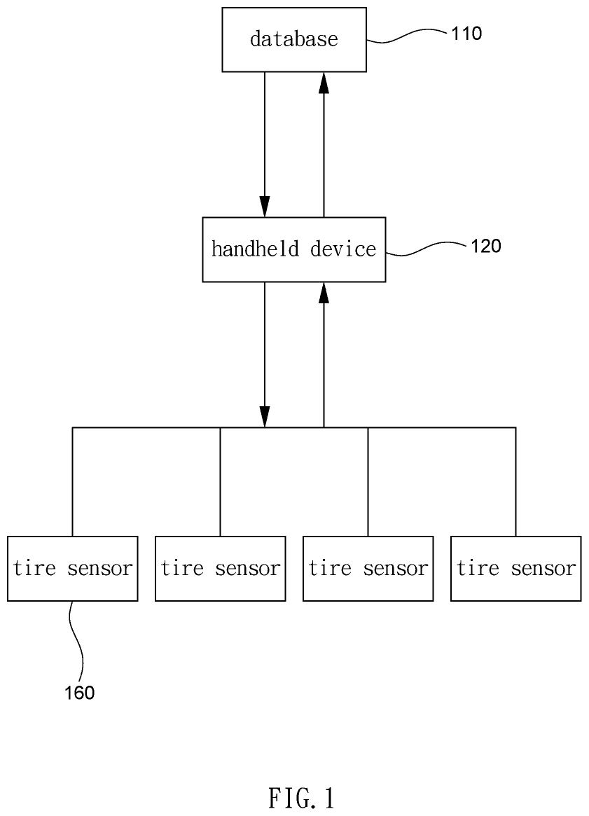

Please refer to FIG. 1. In FIG. 1, a system for setting multiple tire sensor identification codes includes a database 110, a handheld device 120 and multiple tire sensors 160.

The database 110 can be a remote server or a cloud database. The database 110 can be used to input and store a plurality of vehicle owner information and a plurality of tire sensor identification codes and installation locations of the tire sensors 160 which are associated with the vehicle owner information. The vehicle owner information can be a vehicle identification number (VIN), a license plate number, a vehicle owner name, etc. The installation location is the location that the tire sensor 160 installed on the vehicle, such as left front, right front, left rear, right rear, etc. The tire sensor identification code refers to the identification code of each of the tire sensor 160. Each of the tire sensors 160 has a unique identification code, a tire pressure receiver or a car computer can identify each of the tire sensor 160 through a received tire pressure signal which contains the tire identification code. The identification code can be any one or a combination of a number, a code or a symbol, and can be used to identify the tire sensor 160.

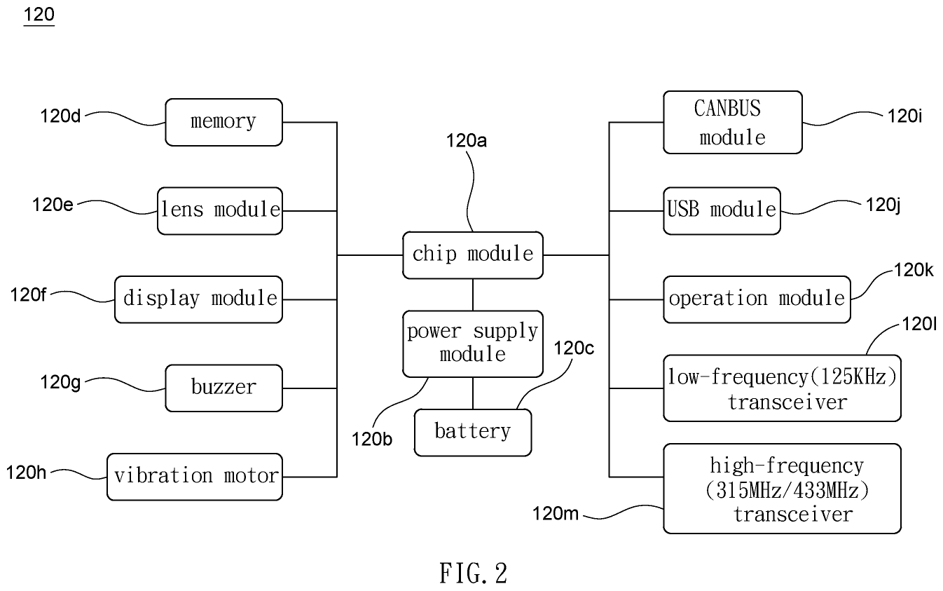

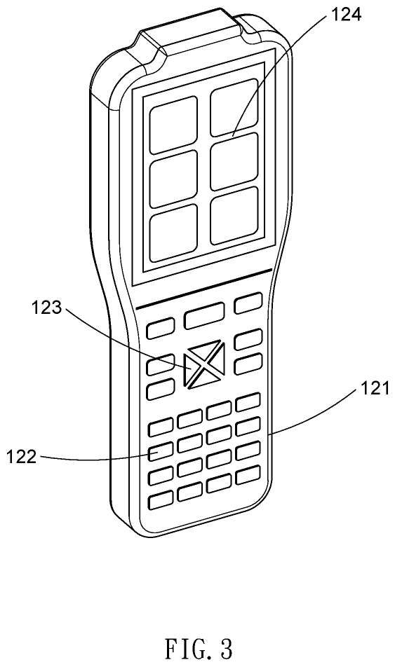

The handheld device 120 is primarily a handheld tool that can be used independently from the vehicle. The handheld device 120 can be carried and used by a user at any predetermined place. The handheld device 120 can be a mobile phone or a tablet. In the embodiment of the present disclosure, the handheld device 120 can be a setting tool of a tire, as shown in FIGS. 2 and 3. The handheld device 120 is commonly manufactured or sold by a tire pressure sensor manufacturer. The handheld device 120 can include a circuit board and a chip module 120a installed thereon. The chip module 120a is a control center, a power supply module 120b, a memory 120d, a lens module 120e, a display module 120f, a buzzer 120g, a vibration motor 120h, a controller area network (CANBUS) module 120i, a USB module 120j, an operation module 120k, a low-frequency (125 KHz) transceiver 120l, a high-frequency (315 MHz/433 MHz) transceiver 120m, a first Bluetooth module, a radio frequency identification (RFID) writer and a Near Field Communication (NFC) module (a NFC circuit) can be electrically connected to the chip module 120a and are controlled by the chip module 120a. It should be mentioned that the handheld device 120 is a device carried by a user's hand, and is not a car computer or a tire pressure receiver connected to the car computer, the tire pressure receiver or the car computer will receive the tire pressure signal from the tire sensor 160. Furthermore, when the handheld device 120 is a tire sensor setting tool, it has a low-frequency (125 KHz) transceiver 120l and can transmit a low-frequency (LF) signal to the tire sensor 160. The handheld device 120 also has a high-frequency 315 MHz/433 MHz) transceiver 120m, and the high-frequency transceiver can be used to receive high-frequency tire pressure signal from the tire sensor 160. In this situation, the handheld device 120 cannot be a mobile phone or a tabled owing to the mobile phone or the tablet doesn't have the low-frequency (125 KHz) transceiver 120l and the high-frequency (315 MHz/433 MHz) transceiver 120m. When the handheld device 120 is a mobile phone or a tablet, it includes a first Bluetooth module and an NFC module, when the handheld device 120 is a tire sensor setting tool, it includes a low-frequency (125 KHz) transceiver 120l and a high-frequency (315 MHz/433 MHz) transceiver 120m, or can further include a first Bluetooth module. The memory 120d can record the tire sensor identification code, the installation location of the tire sensor 160 on the vehicle or the vehicle owner information.

The chip module 120a has logic operation functionalities and integrates with a wireless communication chip. The chip module 120a can exchange data with external devices through various communication protocols (e.g., Wi-Fi, Bluetooth, 3G, 4G, 5G or 6G, etc.). For example, the data can be exchanged with a remote server through a Wi-Fi protocol, or can be exchanged with a mobile phone with a Bluetooth protocol. The network module of the handheld device 120 can be a controller area network (CANBUS) module 120i or a wireless communication chip, the network module is connected to a remote server or a cloud database. It should be mentioned that the first Bluetooth module can be used independently from the chip module 120a or can be integrated in the chip module 120a, and the first Bluetooth module can be a Bluetooth circuit.

The power supply module 120b provides necessary power for hardware operation. In one example, the power supply module 120b can use a battery 120c as a power source, but it is not limited herein.

The memory 120d can store data and several communication protocols, software programs can be loaded into the memory 120d to process vehicle service information and tire operation information. The vehicle service information can include a tire buyer name, a tire seller name, a tire buyer address, a tire seller address, a tire identification (ID), etc., and the tire operation information can include a tire pressure, a tire temperature, a tire sensor electricity, a tire sensor identification code, etc.

The lens module 120e can be equipped with a lens assembly to scan or take pictures of the appearance of a vehicle, the license plate number or the number on the tire skin. The number on the tire skin can be the tire ID. After scanning or taking pictures of the license plate number through the lens module 120e, photos are transmitted to the chip module 120a, and then an image recognition software can be used to identify the photos, thus the vehicle owner information can be known, and the vehicle owner information is transmitted to the database 110 and stored in the database 110.

The display module 120f can display a touch input interface. The vehicle owner information can be inputted through the touch input interface. The vehicle owner information can include a vehicle owner's name, a vehicle owner address, a vehicle owner email, a vehicle owner phone number, a license plate number or a vehicle identification number (VIN), etc. The display module 120f can also be a non-touch input screen.

The low-frequency (125 KHz) transceiver 120l can transmit a trigger signal to the tire sensor 160, and the tire sensor 160 transmits the operation message back after receiving the trigger signal. The low-frequency (125 KHz) transceiver 120l can be a low-frequency (125 KHz) transceiver circuit.

The high-frequency (315 MHz/433 MHz) transceiver 120m can receive the operation messages, and process the operation messages and the vehicle owner information through the software program stored in the memory 120d. The chip module 120a executes instructions of the software program. The instructions of the software program include: generating a user profile to store operation information; transmitting the operation information and the vehicle owner information to the database 110 through the chip module 120a; and transmitting the vehicle owner information through the low-frequency (125 KHz) transceiver 120l. The high-frequency (315 MHz/433 MHz) transceiver 120m can be a high-frequency (315 MHz/433 MHz) transceiver circuit.

The controller area network (CANBUS) module 120i is connected to a receiving device of the vehicle. The receiving device can be a computer built in the vehicle, or can be an external stand-alone device that can connect to the car computer wirelessly or through a cable (plug into the cigarette hole), such as a tire pressure receiver.

The universal serial bus (USB module) 120j can be wired to external mobile phones or computers.

The operation module 120k can be used to confirm function using operating buttons or knobs, and can be used to input the vehicle owner information.

The buzzer 120g and the vibration motor 120h can generate sound or vibrate for warning when an error occurs.

Furthermore, the above handheld device 120 can include a slot. An additional memory (e.g., SD card) can be inserted into the slot for storing the operation information or the vehicle owner information.

As shown in FIG. 3, the handheld device 120 can include a grip 121, a button 122 (acted as a confirmation button or a return button), a function selection key 123 and a touch input interface 124. The button 122 and the function selection key 123 can be incorporated with software programs to perform different functions, a port can be connected to the external mobile phone or computer. One slot of the handheld device 120 can be equipped with an additional memory (e.g., SD card). The physical product structure of the handheld device 120 of the present disclosure is not limited to the above embodiments, it can also have other kinds of physical product structure.

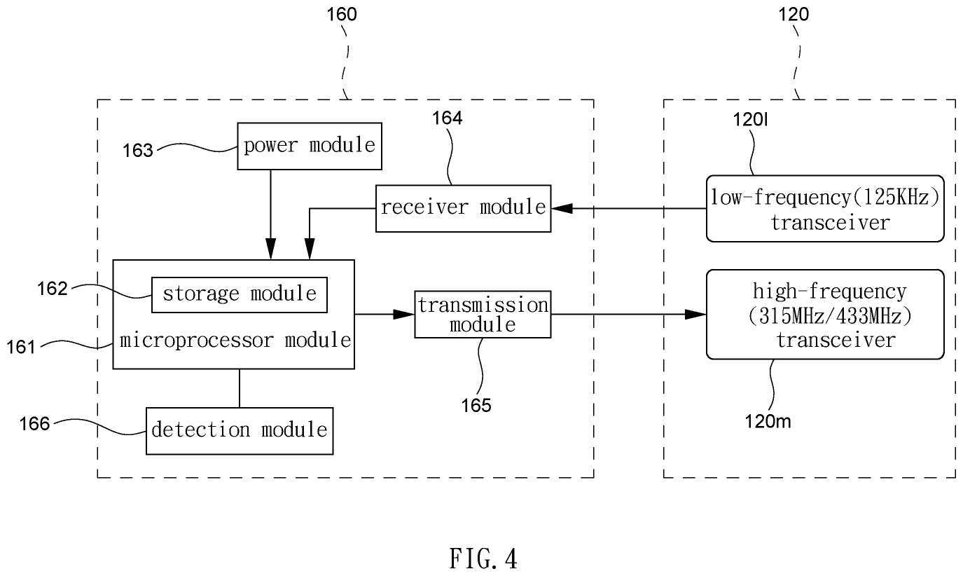

Please refer to FIG. 4, each of the tire sensors 160 can include a storage module 162 and a receiver module 164. The storage module 162 can store the operational information. The receiver module 164 is electrically connected to the storage module 162, and can receive the tire sensor identification code and/or the installation location, and the storage module 162 stores the identification code and/or the installation location. The tire sensor 160 can further include a microprocessor module 161, a power module 163, a transmission module 165, a detection module 166, a second Bluetooth module and an NFC circuit. The power module 163, the transmission module 165, the NFC circuit, the receiver module 164, the second Bluetooth module and the detection module 166 are electrically connected to the microprocessor module 161. The transmission module 165 can transmit tire pressure signals with radio frequency (RF) signals, such as 315 MHz or 433 MHz. The receiver module 164 can receive a low-frequency signal from the low-frequency transceiver 120l of the handheld device 120. The second Bluetooth module can transmit a Bluetooth tire pressure signal to the first Bluetooth module of the handheld device 120. The detection module 166 detects tire pressure or tire temperature, and the transmission module 165 or the second Bluetooth module transmits the tire pressure signal (including tire temperature) to the external tire pressure receiver, the car computer or the handheld device 120. It should be mentioned that the second Bluetooth module can be used independently of the microprocessor module 161, or can be integrated in the microprocessor module 161. The detection module 166 can be a tire pressure sensor or a tire temperature sensor. The transmission module 165 can be a transmission circuit. The receiver module can be a receiver circuit. The second Bluetooth module can be a Bluetooth circuit. The storage module 162 can be a readable and writable memory. The storage module 162 can record the identification code of the tire sensor 160, the installation location of the tire sensor 160 on the vehicle or the vehicle owner information. In one embodiment, the handheld device 120 can include an output module. The output module of the handheld device 120 is controlled by the first chip module 120a to transmit the identification code to the receiver module 164 of a code-writable tire sensor 160.

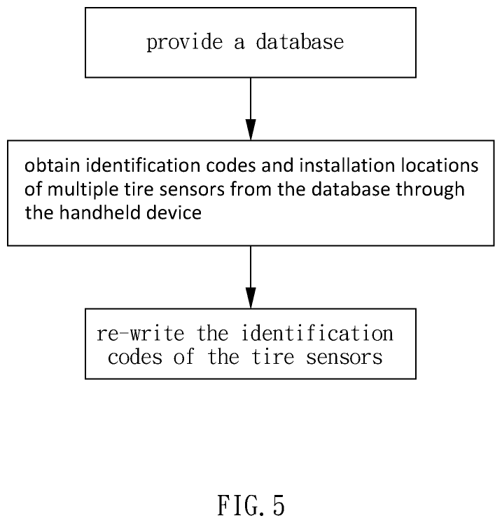

Please refer to FIG. 5, and FIGS. 1 and 2 are also referred herein, a method for setting multiple tire sensors identification codes of the present disclosure includes the following steps.

A database 110 is provided for storing multiple vehicle owner information, multiple tire sensor identification codes associated with the owner information and installation locations of multiple tire sensors 160 on the vehicle. It should be mentioned that a plurality of different vehicle owner information, tire sensor identification codes and/or installation locations are stored on the database. For example, the database stores the name of a vehicle owner A, his vehicle owner information (VIN, license plate number, vehicle owner name, vehicle owner phone number, vehicle owner address, vehicle owner Email, etc.), the tire sensor identification codes 1, 2, 3 and 4, and the installation locations of the four tire sensors 160 on the vehicle (left front, left rear, right front and right rear). The database 110 also stores the name of a vehicle owner B, his vehicle owner information and related tire sensor identification codes and/or installation locations. Therefore, the vehicle owner information of the vehicle owner A should be associated with the tire sensor identification codes 1, 2, 3, 4, and/or the installation locations of tire sensors 160 on the vehicle to distinguish from the vehicle owner information of the vehicle owner B and its related tire sensor identification codes and/or installation locations.

Therefore, when one of the vehicle owner information of the vehicle owner A is inputted into the handheld device 120, the tire identification codes 1, 2, 3, 4 and/or the installation locations associated with the vehicle owner information can be searched on the database 110, but the vehicle owner information of the vehicle owner B and its related tire identification codes and/or installation locations won't be searched.

A wire or wireless connection to the database 110 is established by the controller area network (CANBUS) module 120i of the handheld device 120 or a wireless communication chip, multiple tire sensor identification codes and/or installation locations of the tire sensors 160 are obtained from the database 110 to the handheld device 120. A vehicle owner information can be inputted into the handheld device 120. The lens module 120e can be used to obtain messages (e.g., license plate number) by scanning or taking pictures; the vehicle owner information such as vehicle owner name, vehicle owner phone number, VIN, etc., can be inputted through the display module 120f or the operation module 120k, and the vehicle owner information can be uploaded to the database 110. Therefore, the related tire sensor identification codes and/or the installation locations can be searched through the vehicle owner information stored in the database 110. For example, general vehicle will be equipped with four tire sensors 160, and the four tire sensors identification codes and/or installation locations associated with the vehicle will be searched and transmitted to the handheld device 120. The display module 120f or the operation module 120k can also be used to input the tire sensor identification codes and/or the installation locations.

The tire sensor identification codes are re-written, the low-frequency transceiver 120i or the first Bluetooth module of the handheld device 120 transmits old tire sensor identification codes and/or installation locations to the receiver module 164 or the second Bluetooth module of new tire sensors 160 to replace the original identification codes of the new tire sensor 160 (or the new tire sensors 160 originally did not have identification codes in the storage module 162 thereof), so that the new tire sensors 160 have identification codes and/or installation locations. In another example, the NFC module of the handheld device 120 can also be used to transmit a signal (including identification codes and/or installation locations) to the NFC circuit of the new tire sensors 160. In addition to the wireless connection, the new tire sensors 160 and the handheld device 120 can be connected physically. For example, the new tire sensor 160 can also be connected to the handheld device 120 through a cable, and the signal (including identification codes and/or installation locations) can be transmitted to the new tire sensor 160 through the cable. In order to ensure that the new tire sensor 160 receives the identification codes of the old tire sensor 160, the new tire sensor 160 will transmit back a signal including identification codes to the handheld device 120, and determine whether the identification codes obtained from the new tire sensor 160 are the same as the identification codes obtained from the database 110, if not, the handheld device 120 must obtain the old tire sensor identification codes from the database 110 again. If the same, indicating that the identification codes of the old tire sensors 160 are successfully written to the new tire sensors 160.

Therefore, when the old tire sensors 160 are failure, damaged, aged or ran out of electric power and should be replaced by new ones, the new tire sensors 160 can use the identification codes and installation locations of the old tire sensors 160, thus the car computer can directly identify the new tire sensors 160 with the old identification codes, there is no need to go through a complex code learning process to set the identification codes of the new tire sensors 160. Therefore, the efficiency of setting multiple tire sensor identification codes can be enhanced, the time required for setting the identification code can be shorten as well, thereby increasing overall efficiency and accuracy.

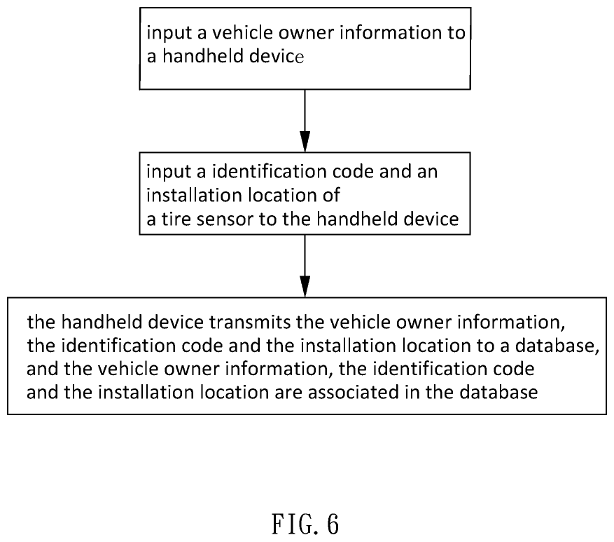

The establishment of the data such as the vehicle owner information, the identification codes and the installation locations in the database 110 can be achieved through the method shown in FIG. 6.

A vehicle owner information (including a vehicle identification number (VIN), a license plate number, a vehicle owner name, etc.) is inputted to the handheld device 120.

An identification code and an installation location of an old tire sensor 160 is inputted to the handheld device 120.

The handheld device 120 transmits the vehicle owner information, the identification code and/or the installation location to the database 110 for storage, and the vehicle owner information and its related identification code and/or installation location are associated in the database 110; or without using the database 110, the vehicle owner information and its related identification code and/or installation location are directly associated and then stored in the database 110. The above information is stored in the memory 120d or in the database 110. In another example, the vehicle owner information and its related identification code and/or installation location can also be associated and stored in the car computer or the tire pressure receiver connected to the car computer. Or the car computer and the tire pressure receiver are connected to a database through a network, then the vehicle owner information and its related identification code and/or installation location can also be associated and stored in the database.

The advantages of the present disclosure are as follows:
1. The identification codes and/or the installation locations of the old tire pressure sensors can be rapidly obtained from the database and transmitted to the handheld device. There is no need to input the identification codes and/or the installation locations of the old tire sensors one by one to the handheld device. In the conventional technology, four old tire sensors need four times input actions, and it takes a lot of time. Therefore, it saves a lot of time in the present disclosure.
2. There is no need to take the handheld device inside the vehicle, no need to plug the handheld device into a cable and then plug the cable into the on-board diagnostic system (OBD), thus there is no need to worry about the risk of losing the cable. Furthermore, owing to there is no need to plug the cable and no need to operate in the car, it saves a lot of time in the present disclosure.
3. Since the vehicle owner information, the tire sensor identification code and/or the installation location are stored in the database, there is no need to worry about the incorrect or missing data obtained from the car computer due to the failure of the car computer. Furthermore, there is no need to worry about the problem that the identification code cannot be obtained from the handheld device due to the damage of the old tire pressure sensor or the break of the identification code attached to the tire pressure sensor.
4. In the conventional technology, the old tire pressure sensor needs to be placed nearby the handheld device, so that the handheld device can obtain the identification code and/or the installation location of the old tire pressure sensor from the old tire pressure sensor. In the present disclosure, there is no restrictions to the space which the old tire pressure sensor placed. The identification code of the old tire pressure sensor can be rapidly and conveniently obtained from the database when the handheld device is connected to the database. The old tire pressure sensor is not required.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A system for setting multiple tire sensor identification codes, comprising:
a database for inputting and storing multiple vehicle owner information and multiple tire sensor identification codes associated with the vehicle owner information; and
a handheld device for obtaining the multiple tire sensor identification codes from the database and transmitting the multiple tire sensor identification codes to multiple tire sensors so that each of the tire sensors stores one tire sensor identification code.

2. The system of claim 1, wherein the database further stores installation locations of the multiple tire sensors, when the handheld device obtains the identification codes of the multiple tire sensors from the database, the installation locations associated with the multiple tire sensors are obtained simultaneously.

3. The system of claim 1, wherein the vehicle owner information comprises a vehicle identification number (VIN), a license plate number, a vehicle owner name, etc.

4. The system of claim 1, wherein the handheld device comprises:
a circuit board;
a chip module installed on the circuit board;
a power supply module;
a memory;
an operation module;
a controller area network module;
a Wi-Fi module;
a first Bluetooth module;
a display module;
a USB module;
a low-frequency (125 KHz) transceiver; and
a high-frequency (315 MHz/433 MHz) transceiver;
wherein the power supply module, the memory, the operation module, the controller area network module, the Wi-Fi module, the first Bluetooth module, the display module, the USB module, the low-frequency (125 KHz) transceiver and the high-frequency (315 MHz/433 MHz) transceiver are electrically connected to the chip module and are controlled by the chip module.

5. The system of claim 1, wherein each of the tire sensor comprises:
a storage module:
a receiver module electrically connected to the storage module;
a microprocessor module;
a power module;
a transmission module; and
a detection module;
wherein the receiver module, the power module, the transmission module and the detection module are electrically connected to the microprocessor module.

6. The system of claim 1, wherein when a vehicle owner information is inputted to the handheld device, the handheld device obtains multiple tire sensor identification codes associated with the vehicle owner information from the database.

7. A system for setting a tire sensor identification code, comprising:
a database for inputting and storing a vehicle owner information and a tire sensor identification code associated with the vehicle owner information; and
a handheld device for obtaining the tire sensor identification code from the database and transmitting the tire sensor identification code to a tire sensor so that the tire sensor stores the tire sensor identification code.

8. The system of claim 7, wherein when a vehicle owner information is inputted to the handheld device, the handheld device obtains a tire sensor identification code associated with the vehicle owner information from the database.

9. A method for setting multiple tire sensor identification codes, comprising:
providing a database for inputting and storing multiple vehicle owner information and multiple tire sensor identification codes associated with the vehicle owner information;
providing a handheld device for obtaining the multiple tire sensor identification codes from the database; and
transmitting one of the multiple tire sensor identification codes to one tire sensor by the handheld device.

10. The method of claim 9, wherein the database further stores installation locations of the multiple tire sensors, when the handheld device obtains the identification codes of the multiple tire sensors from the database, the installation locations associated with the multiple tire sensors are obtained simultaneously.

11. The method of claim 10, wherein before the tire sensor identification codes and the installation locations are obtained by the handheld device, one of the vehicle owner information is inputted to the handheld device, the tire sensor identification code and the installation location associated with the vehicle owner information are searched in the database and then transmitted to the handheld device.

12. The method of claim 9, wherein the vehicle owner information comprises a vehicle identification number (VIN), a license plate number, a vehicle owner name, etc.

13. The method of claim 11, wherein after a signal comprising the tire sensor identification code and/or the installation location transmitted from the database are received by the handheld device, the signal is verified that whether the signal has identification code, whether the signal has a specific length information or a fixed format to determine whether the signal is affirmative.

14. The method of claim 13, wherein the tire sensor transmits back a signal to the handheld device, and the signal comprises the tire identification code.

15. The method of claim 14, wherein the handheld device determines whether the tire identification code obtained from the database is the same as the tire identification code received from the tire sensor.

16. The method of claim 15, wherein when the handheld device determines that the tire identification code obtained from the database is not the same as the tire identification code received from the tire sensor, the handheld device receives the tire identification code agarin from the database.

17. A handheld device, comprising:
a network module, wherein the network module is electrically connected to a database, the network module obtains at least one tire sensor identification code from the database and transmits the at least one tire sensor identification code to at least one tire sensor, so that the tire sensor stores at least one tire sensor identification code.

18. The handheld device of claim 17, wherein the tire identification code and an installation location are transmitted to the database and are stored in the database through the network module.

19. The handheld device of claim 17, further comprising:
a circuit board;
a chip module installed on the circuit board;
a power supply module;
a memory;
an operation module;
a controller area network module;
a Wi-Fi module;
a first Bluetooth module;
a display module;
a USB module;
a low-frequency (125 KHz) transceiver; and
a high-frequency (315 MHz/433 MHz) transceiver;
wherein the power supply module, the memory, the operation module, the controller area network module, the WiFi module, the first Bluetooth module, the display module, the USB module, the low-frequency (125 KHz) transceiver and the high-frequency (315 MHz/433 MHz) transceiver are electrically connected to the chip module and are controlled by the chip module.

20. The handheld device of claim 17, wherein when a vehicle owner information is inputted to the handheld device, the handheld device obtains a tire sensor identification code associated with the vehicle owner information from the database.

21. A device for setting a tire sensor identification code, comprising:
a handheld device comprising a first circuit board, a first chip module, a network module, an output module and a power supply module;
wherein:
the first chip module is installed on the first circuit board, the network module, the output module and the power supply module are electrically connected to the first chip module and are controlled by the first chip module;
the network module receives a network signal from a database and transmits the network signal to the first chip module, wherein the network signal comprises an identification code of an outer tire sensor or an identification code of a code-writable tire sensor;
the power supply module provides electricity to the handheld device;
the code-writable tire sensor comprises a microprocessor module, a detection module, a transmission module, a power module and a receiver module, wherein the detection module, the transmission module, the power module and the receiver module are electrically connected to the microprocessor module;
wherein:
the output module of the handheld device is controlled by the first chip module to transmit the identification code to the receiver module of the code-writable tire sensor;
the detection module is controlled by the microprocessor module to detect a tire pressure value;
the transmission module is controlled by the microprocessor module to transmit a radio frequency (RF) signal comprising the tire pressure value and the identification code of the code-writable tire sensor;
the microprocessor module comprises a memory unit, wherein the memory unit is a readable and writable memory unit;
the receiver module is controlled by the microprocessor to receive the identification code of the outer tire sensor and store the identification code to the memory unit; and
the power module provides electricity to the code-writable tire sensor.

22. The device of claim 21, wherein the identification code is associated with a vehicle owner information, the vehicle owner information comprises a vehicle identification number (VIN), a license plate number and a vehicle owner name.

23. The device of claim 22, wherein after the vehicle owner information is inputted into the handheld device, the vehicle owner information is transmitted to the database through the network module, and the handheld device obtains the identification code associated with the vehicle owner information from the database.

24. A method for setting a tire sensor identification code, comprising:
obtaining an old identification code of an old tire sensor from a database by using a network signal; and
inputting the old identification code to another code-writable tire sensor to form an identification code of the code-writable tire sensor.
